(19) United States
(12) Patent Application Publication
(10) Pub. No.: US 2006/0265528 A1
(43) Pub. Date: Nov. 23, 2006

(54) Method and system for notification and management of item disposal

(76) Inventors: Matt F. Rutkowski, Pflugerville, TX (US); Thomas A. Bellwood, Austin, TX (US); Robert B. Chumbley, Austin, TX (US); Richard B. Allen, Lago Vista, TX (US)

Correspondence Address: JANIS E. CLEMENTS, 3112 LOMITA DRIVE, AUSTIN, TX, 78738, US

(21) Appl. No.: 11/133,426

(22) Filed: May 19, 2005

(51) Int. Cl. G06F 13/38

(52) U.S. Cl. 710/62

(57) ABSTRACT

A system for notification and management of item disposal is useful to provide a passive means of detecting the disposal of an item, association of disposal characteristics with the item, creation of disposal events with user based criteria, and support for subscription to notifications based upon the disposal events. In the present invention, the disposal of an item with a particular set of characteristics can generate notification to a subscriber regarding handling of the item. The present invention can include meta-data describing relative priority or other relevant information for a particular event to a subscriber associated with the item. The notification of the present invention can be via E-mail, pagers, personal digital assistants, or the like.

### TECHNICAL FIELD

The present invention relates to notification and management of item disposal and particularly to functions in the basic input/output system (BIOS) and OS that allow a user to associate data about said item with the item so that when the disposal of the item is detected, a subscriber is notified regarding subsequent actions required as a result of the disposal of the item.

### BACKGROUND OF RELATED ART

In the current art relating to the notification and management of item disposal, the significance surrounding the disposal of items is often neglected. Existing mechanisms that attempt to track the disposal of items require manual intervention and are thus error prone, and/or are often associated with environments where processing involves the handling of hazardous or high value items. Presently, most of the current art notification and management systems for item disposal rely on reactive behavior and simply signal that an anomaly has occurred. Also, the current art is not proactive and does not allow for a flexible means of managing disposal items.

### SUMMARY OF THE PRESENT INVENTION

The present invention provides a method and system for notification and management of item disposal using an operating system (OS) and particularly to functions in the basic input/output system (BIOS) and OS that allow a user to more efficiently manage the disposal of certain items that may be hazardous to the environment or to people, or to initiate actions associated with such disposal. When an item is discarded, a user can implement various means with the present invention to detect not only that the item has been discarded, but also associate with the item additional meta-information about the item, such as its mass, composition, hazardous substance attributes, decomposition properties, and the like. A “disposal event” of the present invention is the act of throwing an item away, detecting and identifying the item being discarded, and taking some action based on that knowledge. This “disposal event” allows a user to establish a rich set of data around which an intelligent and autonomic set of notifications can be constructed. An individual item's disposal can have multiple characteristics which would need to be considered at the time of disposal. Any one or more of these characteristics, when taken together, may be of interest to an observer/processing agent. Conditional notification based upon the characteristics of the disposed item is possible. There can be multiple notification events generated from the disposal of a single item, based upon satisfaction of characteristic-based criteria. One can also associate meta-data describing the importance which a particular event has to various subscribers.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a generalized data processing system on which the present invention for notification and management of item disposal may be practiced;

FIG. 2 is a generalized view of an E-mail distribution system in a Web or Internet that may be used in the practice of this invention;

FIG. 3 is an illustrative diagram of an interactive display interface used for the writing of a notification E-mail document indicating requirements for item disposal of the present invention;

FIG. 4 is an illustrative flowchart describing the setting up of the functions for notification and management of item disposal of the present invention; and

FIG. 5 is a flowchart of an illustrative run of the program set up according to FIG. 4.

### DETAILED DESCRIPTION OF THE PREFERRED EMBODIMENT

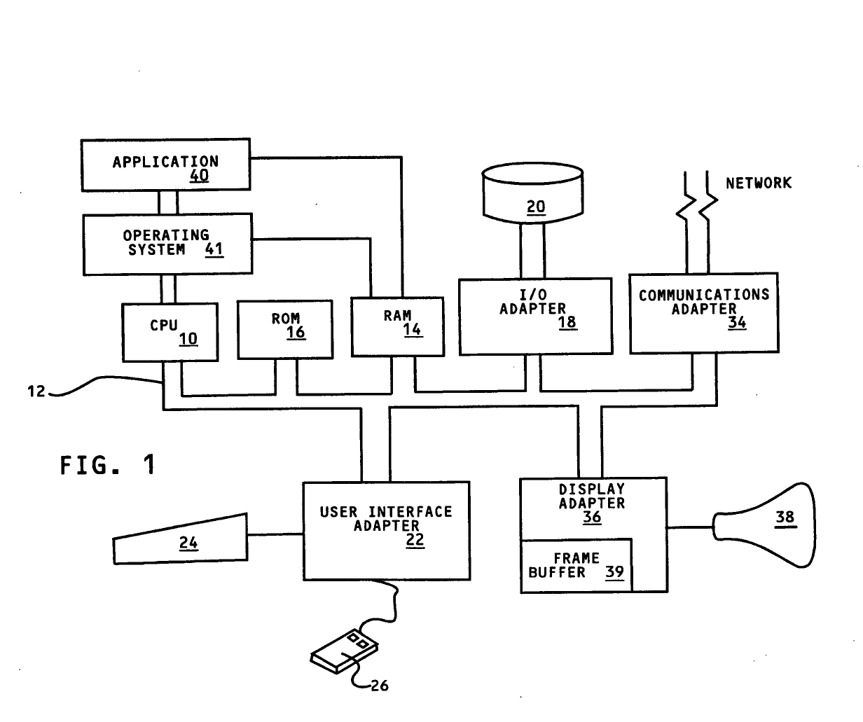

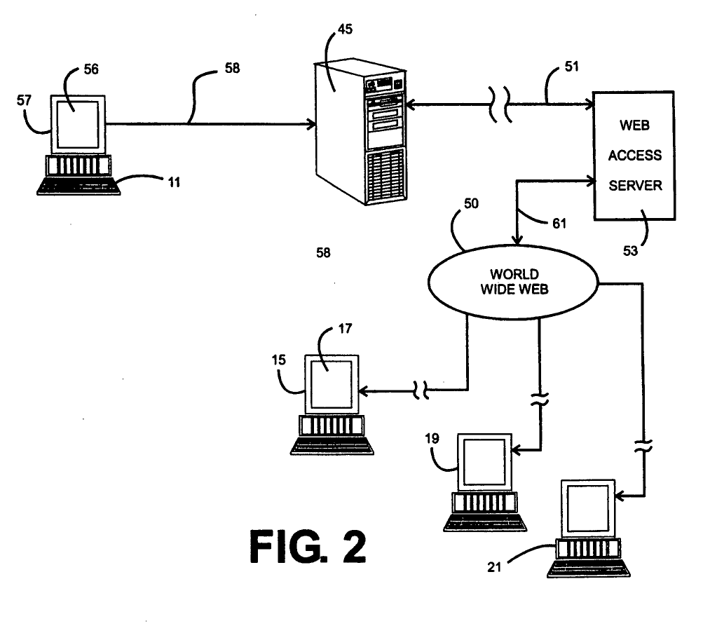

Referring to FIG. 1, a typical data processing system is shown which may function as the computer network terminal or Web station used conventionally as any of the sending or receiving Web stations for electronic mail transmission or other transmission of the notification of the present invention; the system shown is also illustrative of any of the server computers used for the Web E-mail distribution to be described in greater detail with respect to FIG. 2.

A central processing unit (CPU) 10, may be one of the commercial microprocessors in personal computers available from International Business Machines Corporation (IBM), or Dell Corporation; when the system shown is used as a server computer at the Web distribution site, to be subsequently described, then a workstation is preferably used, e.g. RISC System/6000™ (RS/6000) series available from IBM. The CPU 10 is interconnected to various other components by system bus 12. An operating system 41 runs on a CPU 10, provides control and is used to coordinate the functions of the various components of FIG. 1. Operating system 41 may be one of any commercially available operating systems, such as IBM's AIX 5L™ operating system; Microsoft's Windows XP™; or Windows2000™, as well as other UNIX and AIX, or custom operating systems. Application programs 40, controlled by the system, are moved into and out of the main memory Random Access Memory (RAM) 14. These programs include the programs of the present invention for notification and management responsive to disposal of an identified item by associating data about said item with the item, defining a disposal procedure, detecting disposal of the item, carrying out the defined disposal procedure in response to said detection, and taking subsequent actions required by the disposal event. Such notification can be via electronic means, such as E-mail, and can include notification by pagers, personal digital assistants, or the like. Where the computer system shown functions as the receiving Web station, then any conventional Web browser application program, such as Microsoft's Internet Explorer™, will be available for accessing E-mail from the Web and for sending E-mail to the Web from the network station. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 communicates with the disk storage device 20. Communications adapter 34 interconnects bus 12 with the outside network enabling the computer system to communicate with other such computers over the Web or Internet. The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user at a receiving station may interactively relate to the Web in order to access Web documents. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods that may be related to the present invention. Since a major aspect of the present invention is directed to E-mail or like documents transmitted over networks, an understanding of networks and their operating principles would be helpful. We will not go into great detail in describing the networks to which the present invention is applicable. Reference has also been made to the applicability of the present invention to a global network, such as the Internet or Web. For details on Internet nodes, objects and links, reference is made to the text, Mastering the Internet, G. H. Cady et al., published by Sybex Inc., Alameda, Calif., 1996. The Internet or Web is a global network of a heterogeneous mix of computer technologies and operating systems. Higher level objects are linked to the lower level objects in the hierarchy through a variety of network server computers. E-mail is distributed through such a network.

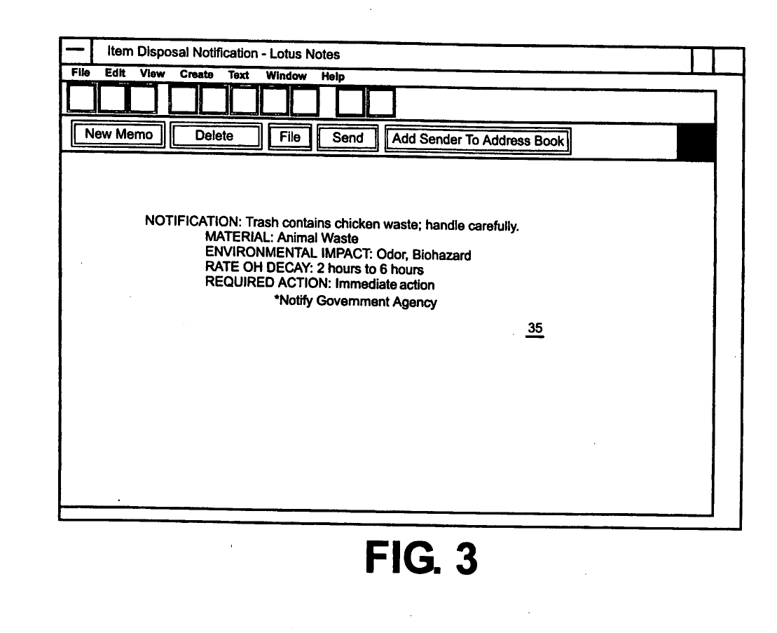

A generalized diagram of a portion of the Web for illustration of the electronic (e.g., E-mail) distribution system of the present invention is shown in FIG. 2. The computer controlled display terminal 11 has a display 57 upon which E-mail documents 56 or other similar notification documents may be created by a sending system and displayed. Terminals 11 and 15 may be implemented by the computer system set up in FIG. 1, and connection 58 (FIG. 2) is the network connection shown in FIG. 1. For purposes of the present embodiment, terminal 11 serves as a Web display station for the sending of E-mail or like notification documents via the display interfaces to be described with respect to FIGS. 3 through 5 via Web browser programs. Reference may be made to the above-mentioned Mastering the Internet, pp. 136-147, for typical connections between local display stations to the Web via network servers, any of which may be used to implement the system on which this invention is used. In the typical set up shown, terminals are connected via, for example, host dial connections (not shown) to server 45 provided by a Web Service Provider that in turn accesses the Web 50 via connection 51 to a Web access server 53 and connection 61. For the purpose of this embodiment, detection of a disposed item occurs on sending system's terminal 11 and notification documents or E-mail 56 are automatically generated and sent over the Web 50 to receiving terminals 15, 19, or 21, which can be subscribers and/or governmental agencies related to item disposal.

In FIG. 3 there is illustrated an E-mail notification document 35 created by a sending system or terminal as shown in FIG. 2, e.g. E-mail on sending terminal 11. The sending terminal automatically creates the notification message 35 in response to receiving a disposal event. The disposal event includes meta-data associated with item being disposed of and can be used to construct the content of the notification E-mail. The actions associated with the disposal of an item are also shown in FIG. 3. Two classes of meta-data are given in a notification message, including disposal characteristics associated with the disposal item, and event notification criteria based on said disposal characteristics. Disposal characteristic meta-data can include material composition (e.g., aluminum, plastic, glass), recycling factors (e.g., recycling classification: type 2 plastic), safe disposal information (e.g., motor oil, batteries, medical waste), environmental impact (e.g., odor, toxic fumes), rate of decay, chemical interactions, and additional factors such as mass, size, and color. The event notification criteria meta-data can include whom to notify for a given disposal event, sets of discrete characteristics which allow a user definable weighting for determination of whether one or more notifications are triggered, characteristic classification code plus arbitrary weighting, notification specific message data (e.g., plain text, information specific to a given event processor), (sub)set of disposal characteristic meta-data. The sending terminal 11 handshakes with a receiving terminal 21 and delivers the notification message 35 that contains information regarding the item being disposed of and the requirements related to the disposal event. In FIG. 3, an example of an E-mail based notification is shown where the item being disposed of is animal waste that is dangerous to the environment because of its odor, biohazardous characteristic, and has a rate of decay of between 2 hours and 6 hours. The message notifies the subscriber that the item disposed of is chicken waste and should be handled carefully. The subscriber is able to receive this information immediately and act upon it before the hazardous waste decays completely.

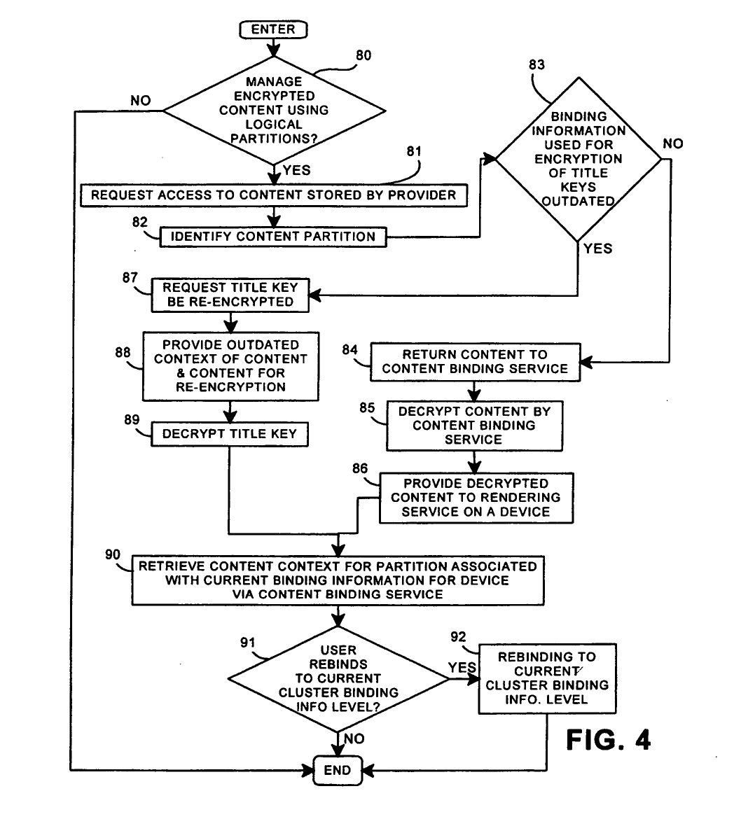

FIG. 4 is a flowchart showing the development of a process according to the present invention for notification and management of item disposal. Means are provided for associating data about an item with the item, step 80. Means are provided for defining a disposal procedure, step 81. Means are provided for detecting disposal of the item, step 82. Means are provided for performing meta-data based notification(s) to subscribers based upon the disposal event, step 83. Means are provided for carrying out the defined disposal procedure in response to said detection, step 84. Means are provided for taking subsequent actions required by disposal event, step 85. Such subsequent actions could include an additional notification, such as one sent to a governmental agency regarding the disposal event when relevant for their involvement in waste disposal efforts of the item. Environmental agencies may benefit from the present invention in conjunction with recycling and waste management efforts.

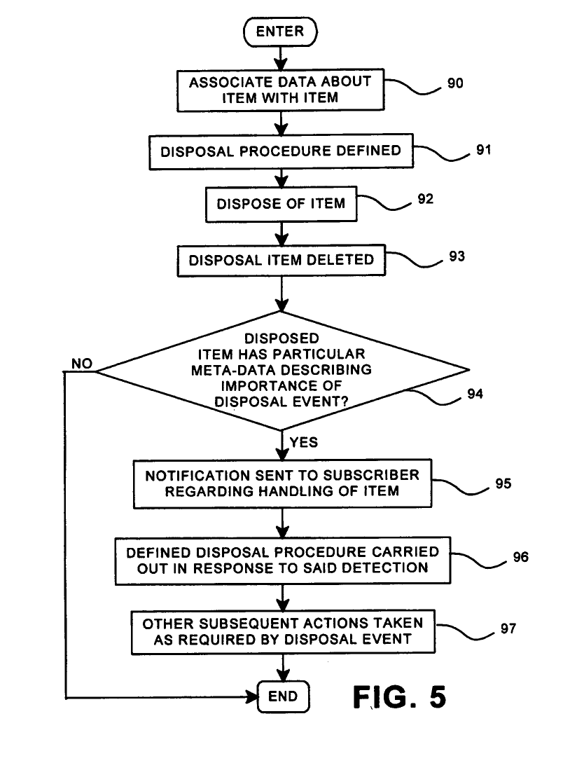

A simplified run of the process set up in FIG. 4 will now be described with respect to the flowchart of FIG. 5. First, meta-data concerning the item being disposed of can be associated with said item, step 90. A disposal procedure is then defined, step 91. Multiple taxonomies could be used to classify to any granularity desired the meta-data regarding each of the aspects of the disposal characteristics. When the item is disposed of, step 92, detection of the disposed item occurs, step 93. RF tags, bar codes, pattern recognition, or similar means can be used to detect and identify the item or class of item being disposed. For example, RF tags can be attached to each item of interest, and would be detected by an RF detection device attached to the waste receptacles in such a way that all items pass by or through the detector as they are discarded. A determination is made as to whether the disposed item has particular meta-data describing the importance of the disposal event to each subscriber, step 94. If No, the process ends. If Yes, a notification is generated and sent to the subscriber regarding the handling of said item, step 95. The act of detection initiates the disposal event, and could be embodied by a device on the internet or home network communicating with a notification system which passes the disposal event information with associated meta-data on to the subscriber. Multiple notifications can be generated and sent to various subscribers based upon the disposal of one or more items. The notification can be sent via E-mail for example. The use of bar codes or pattern recognition operates in a similar way to the use of RF tags. While bar codes are often tied to inventory replenishment systems, their applicability could also be extended for use in the notification system of the present invention. However, the detection mechanism of the bar code technology is less effective than an RF tag or pattern recognition based systems and can be more easily bypassed. In any event, the defined disposal procedure is then carried out in response to said detection, step 96. Other subsequent actions are then taken as required by the disposal event, step 97. It should be noted that special events can be generated if detection of a disposal occurs, but the specific item identification and/or mapping to its associated meta-data fails. This could occur as a result of a failure in the physical detection device, loss of bar code or RF tag, or failure in the pattern recognition system, or upon disposal of an item that has not been catalogued properly.

One of the preferred implementations of the present invention is an application program 41 made up of programming steps or instructions resident in RAM 14, FIG. 1, during computer operations. Until required by the computer system, the program instructions may be stored in another readable medium, e.g. disk drive 20, or in a removable memory such as an optical disk for use in a CD ROM computer input or in a floppy disk for use in a floppy disk drive computer input. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

1. A method for notification and management responsive to disposal of an identified item, the method comprising:
associating meta-data about said item with the item;
a means for subscribers to declare their interest in disposal events in conjunction with meta-data;
defining a disposal procedure involving said meta-data;
detecting disposal of the item;
carrying out the defined disposal procedure in response to said detection; and
taking subsequent actions required by disposal event.

2. The method of claim 1 wherein the disposal of an item with a particular set of characteristics generates notification to a subscriber regarding handling of said item.

3. The method of claim 2 wherein multiple notifications to subscribers are generated from disposal of one or more items.

4. The method of claim 3 wherein meta-data describing importance of a particular disposal event to the subscriber is associated with the item.

5. The method of claim 1 wherein RF tags are attached to said item for identification.

6. The method of claim 1 wherein a pattern recognition system is used on said item for identification.

7. The method of claim 1 wherein the notification is via electronic means.

8. A system for notification and management responsive to disposal of an identified item, the system comprising:
means for associating meta-data about said item with the item;
means for subscribers to declare their interest in disposal events in conjunction with meta-data;
means for defining a disposal procedure involving said meta-data;
means for detecting disposal of the item;
means for carrying out the defined disposal procedure in response to said detection; and
means for taking subsequent actions required by disposal event.

9. The system of claim 8 wherein the disposal of an item with a particular set of characteristics generates notification to a subscriber regarding handling of said item.

10. The system of claim 9 wherein multiple notifications are generated to subscribers from disposal of one or more items.

11. The system of claim 10 wherein meta-data describing importance of a particular disposal event to a subscriber is associated with the item.

12. The system of claim 8 wherein RF tags are attached to said item for identification.

13. The system of claim 8 wherein a pattern recognition system is used on said item for identification.

14. The system of claim 8 wherein the notification is via electronic means.

15. A computer program having code recorded on a computer readable medium for notification and management responsive to the disposal of an identified item, comprising:
associating meta-data about said item with the item;
a means for subscribers to declare their interest in disposal events in conjunction with meta-data;
defining a disposal procedure involving said meta-data;
detecting disposal of the item;
carrying out the defined disposal procedure in response to said detection and
taking subsequent actions required by disposal event.

16. The computer program of claim 15 wherein multiple notifications are generated to subscribers from disposal of one or more items.

17. The computer program of claim 16 wherein meta-data describing importance of a particular disposal event to a subscriber is associated with the item.

18. The computer program of claim 15 wherein RF tags are attached to said item for identification.

19. The computer program of claim 15 wherein a pattern recognition system is used on said item for identification.

20. The computer program of claim 15 wherein the notification is via electronic means.
